(19) United States
(12) Patent Application Publication
(10) Pub. No.: US 2009/0009360 A1
(43) Pub. Date: Jan. 8, 2009

(54) SYSTEM AND METHOD FOR MEASURING AND RECORDING DISTANCE

(76) Inventors: William C. FLANNIGAN, Omaha, NE (US); Brent L. Johnson, Grand Island, NE (US); Jarod O. Adair, Grand Island, NE (US); Terry A. Phillips, Dannebrog, NE (US)

Correspondence Address: SPENCER, FANE, BRITT & BROWNE, 1000 WALNUT STREET, SUITE 1400, KANSAS CITY, MO, 64106-2140, US

(21) Appl. No.: 11/777,454

(22) Filed: Jul. 13, 2007

Related U.S. Application Data
(60) Provisional application No. 60/947,529, filed on Jul. 2, 2007.

(51) Int. Cl. G08C 17/02; B65H 61/00

(52) U.S. Cl. 340/870.03; 33/733; 340/870.02

(57) ABSTRACT

A system (10) and method for measuring and recording distances, such as between structures or reference points on vehicles. The system includes one or more measurement devices (12), each having a cable-extension transducer (14) for generating an electronic signal corresponding to the distance, a microprocessor(16) for determining the distance based upon the electronic signal, and a transceiver (22) operable to wirelessly transmit the distance to a data collection device (26) connected to a computing device (28). The cable-extension transducer (14) is wound about a spool (38) and directed around a wheel (40) such that the wheel (40) turns as the cable (36) is extended or retracted over the distance, thereby allowing for winding the cable (36) in multiple layers about the spool (38). The computing device (28) compares the measured distance to an ideal distance, and reports any difference therebetween.

### RELATED APPLICATIONS

The present non-provisional patent application claims priority benefit of any earlier-filed provisional patent application of the same title, Ser. No. 60/947,529, filed Jul. 2, 2007. The identified earlier-filed application is hereby incorporated by reference as though fully set forth herein.

### FIELD OF THE INVENTION

The present invention relates to systems and method for measuring and recording distances, such as between structures or reference points on vehicles. More specifically, the present invention concerns such a system and method using a cable-extension transducer to provide actual distance data which can be compared with ideal distance data in order to identify differences therebetween which could, for example, indicate a need for structural adjustment when repairing a vehicle.

### BACKGROUND OF THE INVENTION

Cable-extension transducers (CETs), also called “string pots”, “draw wire sensors”, “string encoders”, and “yo-yo sensors”, allow for measuring linear position and velocity. CETs are used in a variety of different applications, including industrial factory automation, high-tech medical devices, structural and automotive testing, die-casting and injection molding, and hydraulic cylinder control.

A CET typically comprises a measuring cable, a spool, a spring, and a rotational sensor, i.e., a potentiometer or an encoder. The cable is wound on the spool such that the spool turns as the cable is extended or retracted. The spring maintains a desired degree of tension on cable. The rotational sensor is coupled with the spool such that, as the spool turns during extension and retraction of the cable, the sensor generates an electrical signal containing information from which the distance and velocity of extension and retraction can be determined. For example, the electrical signal may present a series of spaced apart pulses, the number of which is proportional to distance and the spacing of which is proportional to velocity. Unfortunately, the cable can only be wound on the spool in a single layer because additional layers would have different radii and therefore correspond to different distances, which limits the maximum length of the cable and, therefore, the maximum distance that can be measured.

When a vehicle has been damaged, its structure may be deformed or forced out of alignment. The presence and degree of deformation and misalignment can be determined by measuring the actual distance between two substructures or other reference points on the vehicle, and then comparing the actual distance to an ideal, or standard, distance specified by the vehicle's manufacturer. Laser-based devices exist for precisely measuring distances between such reference points. However, it is sometimes desirable to measure distances between substructures or other reference points in locations which do not allow for use of, or do not allow for convenient use of, such laser-based devices. For example, it is sometimes desirable to measure the dimensions of a door, trunk, or hood opening. Conventional tape measures exist for making such measurements, but they require that the user correctly read the tape measure to a relatively high degree of accuracy, and then manually record the measured distance for subsequent comparison with the ideal distance. As such, it will be appreciated that the use of conventional tape measures creates a significant risk of error in initially reading the tape measure and in recording the measured distance.

### SUMMARY OF THE INVENTION

The present invention provides a system and method for more accurately and efficiently measuring and recording distances, such as between structures or reference points on, for example, vehicles. More specifically, the present invention uses a cable-extension transducer to provide actual distance data for comparison with ideal distance data in order to identify differences therebetween which could, for example, indicate a need for structural adjustment when repairing a vehicle.

One embodiment of the system comprises a hand-held measurement device and a data collection device. The measurement device includes a cable-extension transducer operable to generate an electronic signal corresponding to the distance, a microprocessor operable to determine the distance based upon the electronic signal, a display device operable to display the distance in a particular unit of measurement, a transceiver operable to wirelessly transmit the distance, and a control mechanism operable to control transmission of the distance by the transceiver and to allow for selecting the particular unit of measurement. The data collection device is operable to receive the wireless transmission of the distance and to provide the distance to a computing device.

Various embodiments of the system include any one or more of the following additional features. The cable-extension transducer includes a cable; a spool, around which the cable is wound in one or more layers and from which the cable can be extended and retracted over the distance; a wheel, around which the cable is at least partly directed such that the wheel turns as the cable is extended or retracted over the distance; and a rotational sensor operable to detect rotation of the wheel as the cable is extended or retracted over the distance and to generate the electronic signal corresponding to the distance. The electronic signal includes a series of spaced apart pulses, wherein the number of pulses corresponds to the distance. There are a plurality of instances of the measurement device, with each measurement device having a unique identifier recognized by the data collection device. The measurement device further includes a memory for storing the distance, and the control mechanism is further operable to allow for selectively storing the distance in the memory. The system includes the computing device operable to receive the distance from the data collection device, to compare the distance to an ideal distance, and to report any difference therebetween.

One embodiment of the method comprises the steps of generating an electronic signal in response to the extension or retraction of the cable over the distance, wherein the electronic signal corresponds to the distance; determining the distance based upon the electronic signal; allowing for selecting a particular unit of measurement; displaying the distance in the particular unit of measurement; transmitting the distance wirelessly to a data collection device; and communicating the distance from the data collection device to a computing device.

Various embodiments of the method include any one or more of the following additional steps or features. The step of generating the electronic signal is accomplished by the aforementioned cable-extension transducer. The step of generating the electronic signal includes generating the aforementioned series of spaced apart pulses, wherein the number of pulses corresponds to the distance. There is the aforementioned plurality of instances of a measurement device, and the method further includes the step of assigning to each instance of the measurement device the unique identifier recognized by the data collection device. The method further includes the step of allowing for selectively storing the distance in the measurement device. The method further includes the steps of receiving the distance from the data collection device, comparing the distance to an ideal distance, and reporting any deviation therebetween.

From the description step forth herein, it will be appreciated that the present invention provides several advantages over the prior art, including, for example, overcoming the prior art limitation on the maximum length of the cable and, therefore, the maximum distance that can be measured by associating the rotational sensor with the wheel, rather than the spool, which allows for winding the cable about the spool in multiple layers. Additionally, the present invention substantially automatically both determines distance and communicates the determined distance to a computing device for further analysis, thereby minimizing the potential errors of the prior art from incorrectly reading a distance scale and/or incorrectly recording the determined distance.

These and other features of the present invention are described in greater detail in the section titled DETAILED DESCRIPTION OF THE INVENTION, set forth below.

### BRIEF DESCRIPTION OF THE DRAWING FIGURES

The present invention is described herein with reference to the following drawing figures, which are not necessarily to scale:

FIG. 1 is a block diagram of the major components of an embodiment of the system of the present invention;

FIG. 2 is a front elevation view of a measurement device component of the system of FIG. 1;

FIG. 3 is a side elevation view of the measurement device component of FIG.2;

FIG. 4 is a front elevation view of a portion of a cable-extension transducer subcomponent of the measurement device component of FIG. 2;

FIG. 5 is a side elevation view of the cable-extension transducer subcomponent of FIG. 4; and

FIG. 6 is a flowchart of steps involved in practicing an embodiment of the method of the present invention using the system of FIG. 1.

### DETAILED DESCRIPTION OF THE INVENTION

With reference to the drawings figures, a system and method is herein described, shown, and otherwise disclosed in accordance with various embodiments, including a preferred embodiment, of the present invention. Broadly, the system and method allow for more accurately and efficiently measuring and recording distances using a cable-extension transducer. In one contemplated application, the system and method are adapted for use in post-accident vehicle analysis and repair, wherein actual distance data is compared with ideal, or standard, distance data provided by the vehicle's manufacturer in order to identify differences therebetween which could indicate a need for structural adjustment.

As used herein, the term “cable” refers broadly to substantially any extensible and retractable structure, regardless of its cross-sectional shape or the natural, artificial, or combination of materials of which it is made. For example, the term “cable” includes, without limitation, wire, string, rope, fiber, and filament, and includes, without limitation, round, polygonal, and flat cross-sectional shapes.

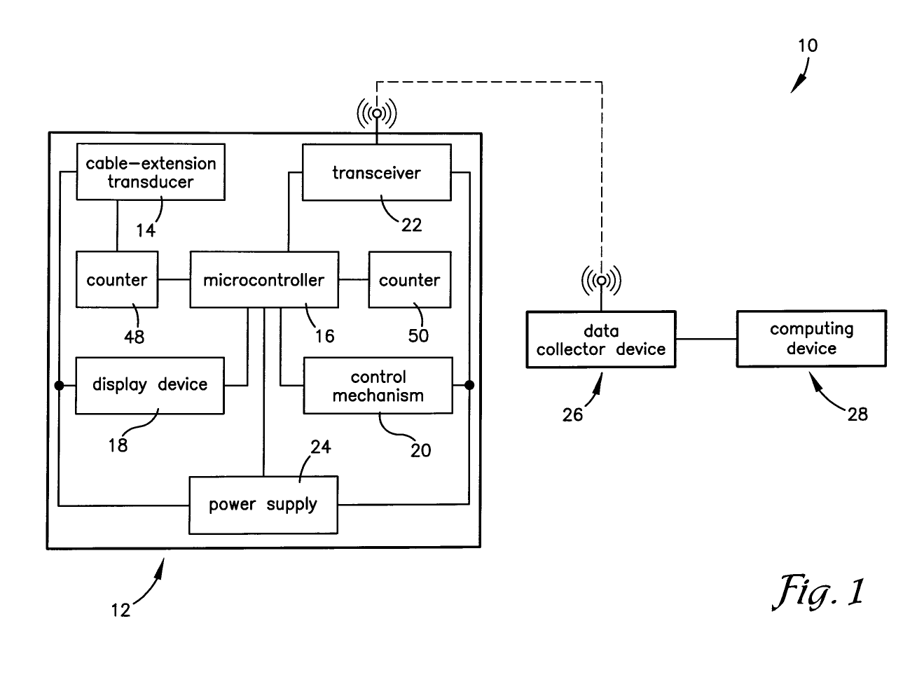

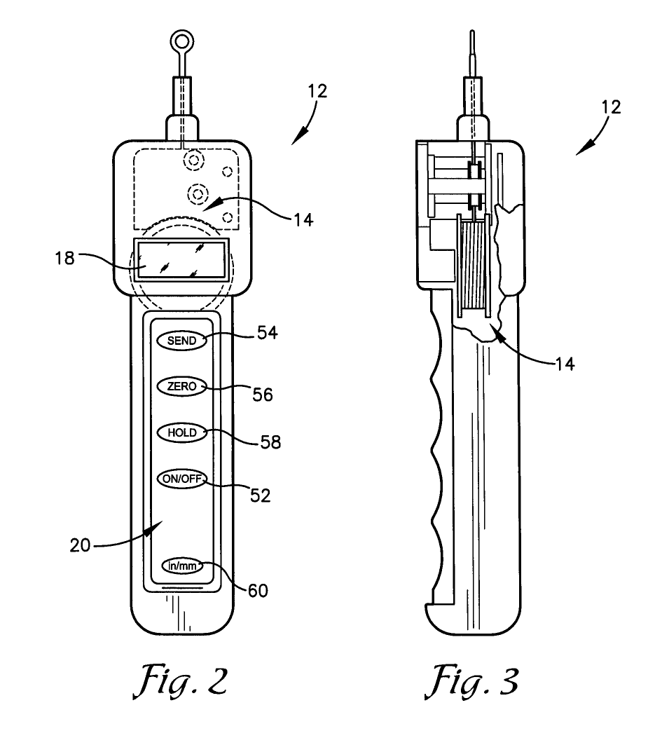

In the embodiment shown in FIGS. 1-3, the system 10 broadly comprises a hand-held measurement device 12, including a cable-extension transducer 14, a microprocessor 16, a display device 18, a control mechanism 20, a transceiver 22, and a power supply 24; a data collection device 26; and a computing device 28.

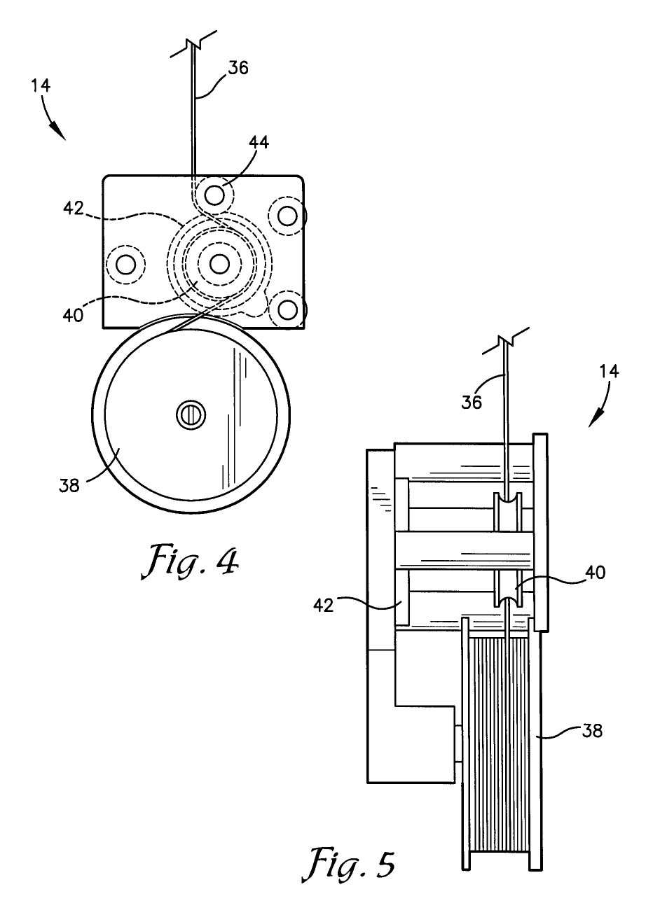

The cable-extension transducer (CET) 14 is operable to provide electronic signals corresponding to a distance. In the embodiment shown in FIGS. 4 and 5, the CET broadly includes a measuring cable 36, a spool 38, a spring (not shown), a wheel 40, and a rotational sensor 42. The cable 36 is wound on the spool 38 such that the spool 38 turns as the cable 36 is extended or retracted. The spring maintains a desired degree of tension on cable 36. The cable 36 is directed at least partly around the wheel 40 such that the wheel 40 also turns as the cable 36 is extended or retracted. In one embodiment, a tensioning mechanism 44, such as a tensioning wheel or arm, is included to maintain the cable 36 in a sufficiently close relationship with the wheel 40 to prevent slippage. The rotational sensor 42 is coupled with the wheel 40 such that, as the wheel 40 turns, the sensor 42 generates an electrical signal containing information from which the distance (and velocity) of the cable's extension and retraction can be determined.

In one embodiment, a free end of the cable 36 is attachable to a telescoping or otherwise extensible substantially rigid structure to allow for, e.g., measuring distances longer than the user's arm span.

In one embodiment, the electrical signal presents a series of spaced apart pulses, the number of which is proportional to the distance over which the cable 36 has been extended or retracted. By associating the rotational sensor 42 with the wheel 40 rather than the spool 38, the cable 36 can be wound about the spool 38 in multiple layers, thereby overcoming the prior art limitation on the maximum length of the cable 36 which has limited the maximum measurable distance.

In one embodiment, the CET 14 has a measuring range of approximately between 2.5×10̂2 mm and 2.0×10̂3 mm, an accuracy of approximately ±2 mm over its full range, and a repeatability of approximately ±0.5 mm. In one embodiment, the CET 14 uses a 5 volt power supply and provides the electronic signal in the form of a differential pulse train which meets desired accuracy and repeatability requirements. One potentially suitable off-the-shelf CET on which the CET 14 of the present invention may be based is available from Celesco Transducer Products, Inc., as model A250.

The microprocessor 16 controls operation of the display device 18, the control mechanism 20, the transceiver 22, and power management functionality (discussed below) of the power supply 24.

In one embodiment, the electronic signal generated by the rotational sensor 42 of the CET 14 is input to a counter 48 which counts and stores the number of pulses in realtime. The counter 48 may be integrated into or separate from the microprocessor 16. Based upon the counted number of pulses, the microprocessor 16 substantially automatically determines the measured distance. The determined measured distance is substantially automatically displayed on the display device 18 in units, e.g., inches or millimeters, specified by the user, and is substantially automatically communicated via the transceiver 22 to the data collection device 26. In one embodiment, the microprocessor 16 is provided with a memory 50 operable to store the determined distance onboard the measurement device 12.

One potentially suitable off-the-shelf microprocessor on which the microprocessor 16 of the present invention may be based is available from Atmel Corporation as model Atmega 128L.

The display device 18 communicates the measured distance, as determined by the microprocessor 16, and information regarding operation of the measurement device 12 to a user. In one embodiment, the display device 18 is capable of displaying units as small as 0.01 inches or 1 mm, and uses a 2×8 character LCD display with LED backlighting, wherein the backlighting is controlled by firmware logic.

One potentially suitable off-the-shelf display device on which the display device 18 of the present invention may be based is available from Electronic Assembly GmBH as model EADIPS082.

The control mechanism 20 allows the user to control operation of various aspects of the measurement device 12. In one embodiment, the control mechanism 20 includes at least the following keys: an ON/OFF key 52, a SEND key 54, a ZERO key 56, a HOLD key 58, and an IN/mm key 60. The ON/OFF key 52 allows for manually activating and deactivating the device 12 (substantially automatic activation, partial deactivation, and deactivation functionality is described below). The SEND 54 key allows for sending the measurement data to the data collection device 26. The ZERO key 56 allows for zeroing measurement correction and/or adjustment values, such as when correcting for temperature effects on the cable 36. The HOLD key 58 allows for holding, or storing, the measurement data in the onboard memory 50. The IN/mm key 60 allows for specifying the units, e.g., inches or millimeters, in which the measurement data is displayed on the display device 18.

The transceiver 22 transmits and receives data to and from the data collection device 26. In one embodiment, the transceiver 22 is a wireless RF transceiver, using a communication protocol such as IEEE 802.15.4 or ZigBee, operating in the 2.4 GHz universal ISM band, with a range of approximately ten meters in non-line of site (minor blockages) conditions, and having an onboard chip antenna. In one embodiment, the transceiver is a ZigBee End Device having a unique 64 bit IEEE address.

One potentially suitable off-the-shelf transceiver on which the transceiver 22 of the present invention may be based is available from Ember Corporation as model EM2420.

In one embodiment, the power supply 24 is a plurality, e.g., four, of AA (alkaline or NiMH) cells allowing for several, e.g., eight, hours of continuous use before replacement or recharging. In one embodiment, as mentioned above, power usage by the device 12 is managed by one or more substantially automatic functions, including an “auto-on” function which substantially automatically activates the device 12 for use when a key of the control mechanism 20 is depressed, a “standby” function which substantially automatically partially deactivates the device 12 after a period of non-use, and an “auto-off” function which substantially automatically fully deactivates the device 12 after a further period of non-use.

The data collection device 26 receives measurement data transmitted from the measurement device 12 and provides it to the computing device 28, e.g., a personal computer, for analysis. In one embodiment, the data collection device 26 is connected to the computing device 28 using a USB or other cable. In one embodiment, the data collection device 26 is a simple receiver operable to receive the information transmitted by the transceiver 22 and provide it to the computing device 28.

In one embodiment, the data collection device 26 may receive measurement data from a plurality, e.g., six, of different measurement devices, with each measurement device having a unique IEEE address or other identifier. Measurement devices other than the CET-based device 12 described herein may be among the different devices providing measurement data to the data collection device 26. In one such embodiment, the data collection device 26 is a ZigBee coordinator, the transceivers 22 are, as mentioned, ZigBee End Devices, and the latter communicate with the former over a ZigBee network.

In one embodiment, the data collection device 26 is eliminated or bypassed by manually entering the measurement data displayed on the display device 18 into the computing device 28.

The computing device 28 substantially automatically analyzes the measurement data received via the data collection device 26 from the measurement device 12. In one embodiment, the computing device 28 stores or otherwise accesses and executes software to compare the measured actual distances between structures or reference points with ideal distances to determine and report any differences therebetween.

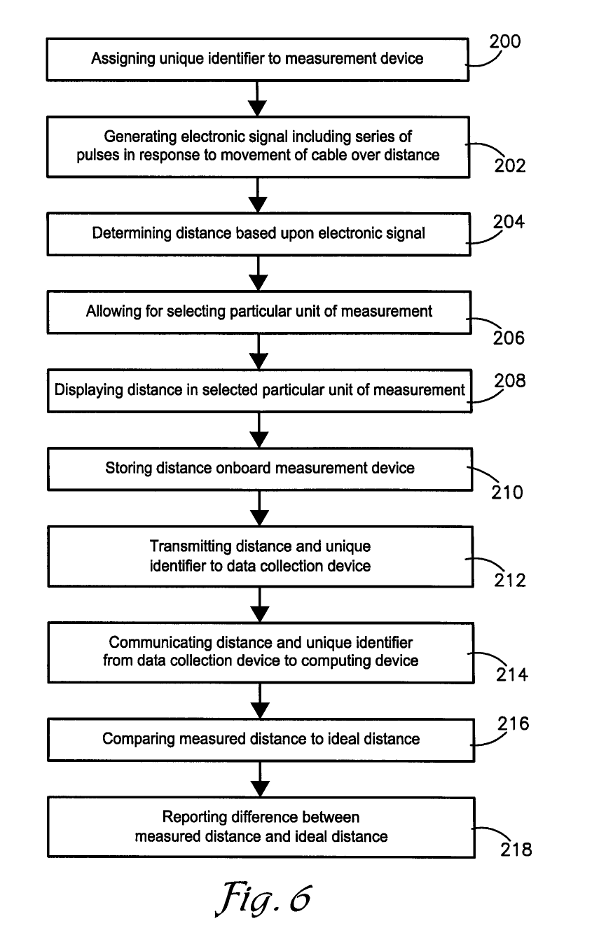

Referring to FIG. 6, in exemplary use and operation the above-described system 10 may be employed in accordance with the following method steps. As mentioned, one or more of the measurement devices 12 may be used substantially simultaneously. Where more than one measuring device 12 is used, each is assigned a unique identifier, as shown in box 200. A user of the measurement device 12 extends the cable 36 between first and second points, thereby causing the rotational sensor 42 to generate an electronic signal which includes a series of spaced apart pulses, as shown in box 202. The number of pulses corresponds to the distance, and the microprocessor 16 determines the distance based upon the electronic signal, as shown in box 204. As desired, the user selects a particular unit of measurement using the control mechanism 20, as shown in box 206. The display device 18 displays the distance in the particular unit of measurement, as shown in box 208. As desired, the user stores the distance in the memory 50 onboard the measurement device 12, as shown in box 210. The transceiver 22 transmits the measured distance and the unique identifier wirelessly to the receiver or data collection device 26, as shown in box 212. The data collection device 26 communicates the distance and the unique identifier to the computing device 28, as shown in box 214. The computing device 28 compares the distance to an ideal distance, as shown in box 216, and reports any difference therebetween, as shown in box 218.

From the foregoing discussion, it will be appreciated that the present invention provides several advantages over the prior art, including, for example, overcoming the prior art limitation on the maximum length of the cable, and therefore the maximum distance that can be measured, by associating the rotational sensor with the wheel, rather than the spool, which allows for winding the cable about the spool in multiple layers. Additionally, the present invention substantially automatically both determines distance and communicates the determined distance to a computing device for further analysis, thereby avoiding the potential errors of the prior art from incorrectly reading a distance scale and/or incorrectly recording the determined distance.

Although the invention has been disclosed with reference to various particular embodiments, it is understood that equivalents may be employed and substitutions made herein without departing from the scope of the invention as recited in the claims. For example, in one embodiment the measurement device may be operable only to transmit the electronic signal generated by the CET rather than to also determine the distance based thereupon.

Having thus described the preferred embodiment of the invention, what is claimed as new and desired to be protected by Letters Patent includes the following:

1. A system for measuring a distance, the system comprising:
a hand-held measurement device including
a cable-extension transducer operable to generate an electronic signal corresponding to the distance, and
a transceiver operable to wirelessly transmit the electronic signal; and a receiver operable to receive the wireless transmission of the electronic signal and
to provide the electronic signal to a computing device.

2. A system for measuring a distance, the system comprising:
a hand-held measurement device including
a cable-extension transducer operable to generate an electronic signal corresponding to the distance,
a microprocessor operable to determine the distance based upon the electronic signal,
a display device operable to display the distance in a particular unit of measurement,
a transceiver operable to wirelessly transmit the distance, and
a control mechanism operable to control transmission of the distance by the transceiver and to allow for selecting the particular unit of measurement; and
a data collection device operable to receive the wireless transmission of the distance and to provide the distance to a computing device.

3. The system as set forth in claim 2, wherein the cable-extension transducer includes
a cable;
a spool, about which the cable is wound in one or more layers and from which the cable can be extended and retracted over the distance;
a wheel, around which the cable is at least partly directed such that the wheel turns as the cable is extended or retracted over the distance; and
a rotational sensor operable to detect rotation of the wheel as the cable is extended or retracted over the distance and to generate the electronic signal corresponding to the distance.

4. The system as set forth in claim 2, wherein the electronic signal includes a series of spaced apart pulses, and wherein the number of pulses corresponds to the distance.

5. The system as set forth in claim 2, wherein there are a plurality of instances of the measurement device, with each measurement device having a unique identifier recognized by the data collection device.

6. The system as set forth in claim 2, the measurement device further including a memory for storing the distance, and the control mechanism being further operable to allow for selectively storing the distance in the memory.

7. The system as set forth in claim 2, further including the computing device operable to receive the distance from the data collection device, to compare the distance to an ideal distance, and to report any difference therebetween.

8. A system for measuring a distance, the system comprising:
a plurality of hand-held measurement devices, with each measurement device having a unique identifier and including
a cable-extension transducer operable to generate an electronic signal including a series of spaced apart pulses, wherein the number of pulses corresponds to the distance,
a microprocessor operable to determine the distance based upon the electronic signal,
a display device operable to display the distance in a particular unit of measurement,
a transceiver operable to wirelessly transmit the distance and the unique identifier, and
a control mechanism operable to control transmission by the transceiver and to allow for selecting the particular unit of measurement;
a data collection device operable to receive the wireless transmission of the distance and the unique identifier; and
a computing device operable to receive the distance and the unique identifier from the data collection device, to compare the distance to an ideal distance, and to report any difference therebetween.

9. The system as set forth in claim 8, wherein the cable-extension transducer includes
a cable;
a spool, about which the cable is wound in one or more layers and from which the cable can be extended and retracted over the distance;
a wheel, around which the cable is at least partly directed such that the wheel turns as the cable is extended or retracted over the distance; and
a rotational sensor operable to detect rotation of the wheel as the cable is extended or retracted over the distance and to generate the electronic signal corresponding to the distance.

10. The system as set forth in claim 8, the measurement device further including a memory for storing the distance, and the control mechanism being further operable to allow for selectively storing the distance in the memory.

11. A method of measuring a distance, the method comprising the steps of:
(a) generating an electronic signal in response to the extension or retraction of a cable over the distance, wherein the electronic signal corresponds to the distance;
(b) determining the distance based upon the electronic signal;
(c) allowing for selecting a particular unit of measurement;
(d) displaying the distance in the particular unit of measurement;
(e) transmitting the distance wirelessly to a data collection device; and
(f) communicating the distance from the data collection device to a computing device for analysis.

12. The method as set forth in claim 11, wherein the step (a) of generating the electronic signal is accomplished by a cable-extension transducer including
a cable;
a spool, about which the cable is wound in one or more layers and from which the cable can be extended and retracted over the distance;
a wheel, around which the cable is at least partly directed such that the wheel turns as the cable is extended or retracted over the distance; and
a rotational sensor operable to detect rotation of the wheel as the cable is extended or retracted over the distance and to generate the electronic signal corresponding to the distance.

13. The method as set forth in claim 11, wherein the step (a) of generating the electronic signal includes generating a series of spaced apart pulses, wherein the number of pulses corresponds to the distance.

14. The method as set forth in claim 11, wherein there are a plurality of instances of a measurement device performing steps (a)-(e), and the method further including the step of assigning to each of the instances a unique identifier recognized by the data collection device.

15. The method as set forth in claim 11, further including the step of allowing for selectively storing the distance on the measurement device.

16. The method as set forth in claim 11, further including the steps of
receiving the distance from the data collection device;
comparing the distance to an ideal distance; and
reporting any difference therebetween.

17. A method of measuring a distance, the method comprising the steps of:
(a) providing a plurality of hand-held measurement devices, wherein each measurement device is independently operable to perform steps (c)-(g);
(b) assigning to each measurement device a unique identifier;
(c) generating an electronic signal in response to the extension or retraction of a cable over the distance, wherein the electronic signal includes a series of spaced apart pulses, and the number of pulses corresponds to the distance;
(d) determining the distance based upon the electronic signal;
(e) allowing for selecting a particular unit of measurement;
(f) displaying the distance in the particular unit of measurement;
(g) transmitting the distance and the unique identifier wirelessly to a data collection device;
(h) communicating the distance and the unique identifier from the data collection device to a computing device;
(i) comparing the distance to an ideal distance; and
(j) reporting any difference between the distance and the ideal distance.

18. The method as set forth in claim 17, further including the step of allowing for selectively storing the distance on the measurement device.
